(19) United States
(12) Patent Application Publication
(10) Pub. No.: US 2002/0195309 A1
(43) Pub. Date: Dec. 26, 2002

(54) Money handling apparatus and method

(76) Inventor: Andrew Simon Pope, Berkshire (GB)

Correspondence Address: Stephan J Filipek, Fish & Richardson P C, 45 Rockefeller Plaza, New York, NY, 10111, US

(21) Appl. No.: 09/528,255

(22) Filed: Mar. 17, 2000

(30) Foreign Application Priority Data
Apr. 8, 1999 (GB) 9908039.2

(51) Int. Cl. G06F 7/00; G06F 9/00; G07F 9/08; G06F 19/00

(52) U.S. Cl. 194/217

(57) ABSTRACT

A money validator, such as a coin validator, can operate with different types of vending machines. With one type of vending machine, the coin validator chooses a suitable scaling factor in accordance with the values of coin denominations which it is intended to accept and transmits the scaling factor for use by the vending machine. The coin mechanism can also respond to a pre-set scaling factor in order to determine which coin denominations should be inhibited, for example because they have values which are not integer divisible by the scaling factor.

This invention relates to apparatus and methods for handling money. It will be described primarily in the context of coin handling, but the techniques of the invention can also be applied to handling other forms of currency, and in particular banknotes.

Many conventional machines for vending products or providing services incorporate at least one controller which operates the product-vending or service-providing part of the apparatus, and at least one further controller within a money handling unit such as a coin validator. The controller in the coin validator communicates with the vend controller in order to perform a number of functions, including transmitting to the vend controller indications of the values of coins validated by the coin validator and receiving from the controller instructions which are used to control the dispensing of change. The division of the functions between these controllers can vary from machine to machine. For example, in some machines, the vend controller is able to calculate the distribution of coins to be dispensed as change, and to provide appropriate instructions to the coin validator. In other arrangements, the vend controller simply sends to the coin validator an indication of the total amount of change to be dispensed (or the price of a product being dispensed), and the coin validator is then capable of calculating an appropriate coin distribution for dispensing.

Monetary values may be transmitted between the controllers in arbitrary units. However, it is necessary that each controller stores information specifying the units being used by the other controller for the information to be meaningful. In practice, both the vend controller and the coin validator controller store a representation of the units, often referred to as the scaling factor. Both controllers transmit value in units determined by this scaling factor. In some cases, this scaling factor has to be individually stored within each device as a manual operation. In other arrangements, the coin validator is capable of performing an initialisation operation (which may for example take place on power-up of the machine, or in response to instructions from a service engineer), by means of which a scaling factor stored in the coin validator is transmitted to the vend controller for storage therein.

The choice of scaling factor depends upon a number of considerations. This includes the number of different denominations which can be handled by the coin validator, and the number of different denominations which the vend controller can recognise (which may be different). As coin validators and vending machines become more sophisticated, and able to handle greater numbers of coins and in some cases different currencies, the selection of an appropriate scaling factor becomes more difficult. Furthermore, each time the configuration of the coin validator is changed, for example to allow the validator to accept and/or dispense a different set of coins, the scaling factor potentially becomes inappropriate and needs to be changed.

Aspects of the present invention are set out in the accompanying claims.

According to a further aspect of the present invention, a money validator is operable to determine, taking into account the values associated with the denominations it is intended to accept and/or dispense, an appropriate scaling factor, and to transmit this scaling factor to a controller of a vending machine. The term “vending machine” is used herein to cover any machine which is intended for the provision of products (including money) or services in response to value received. Thus, in this aspect, the money validator can automatically take into account various parameters, including the coin set with which it is intended to be used, and possibly also for example the denominations it is arranged to dispense, in order to calculate an appropriate scaling factor which can then be used both by the money validator and the vending machine controller. This mitigates the problems associated with changing scaling factors in the event of a reconfiguration of the coin validator.

According to another aspect of the invention, a money validator is operable to inhibit acceptance of currency units in response to a supplied scaling factor. Thus, in those circumstances where the vending machine has a predetermined scaling factor, or where a scaling factor cannot be automatically altered by the money validator, it is possible to specify a scaling factor and reconfigure the money validator automatically so as to avoid the use of currency units which are inappropriate for that scaling factor. This is particularly valuable also when the money validator is capable of handling more denominations than the vending machine controller can handle; this aspect of the invention enables automatic selection of the best combination of currency units.

According to a further aspect of the invention, a money validator is automatically operable to inhibit acceptance of a sub-set of coins selected from a coin set which is nominally capable of being handled by the money validator, the selection taking into account parameters including the currency units which can be dispensed by the money validator. Preferably, the money validator also takes into account a supplied scaling factor in selecting the sub-set, or alternatively calculates a scaling factor from the determined sub-set.

According to a further aspect of the invention, a money validator is operable selectively in either of two modes, the money validator being operable in the first mode to respond to a supplied scaling factor for selectively inhibiting acceptance of one or more denominations, and being operable in the second mode for calculating a scaling factor on the basis of the values of denominations which the money validator is capable of accepting. This enables the same validator to be used to advantage in circumstances where the scaling factor has to be pre-set to match that of a vending machine controller and where the scaling factor can be varied to best suit the coin set which the validator is intended to handle.

The present invention is particularly suitable for use in coin validators in accordance with WO-A-99/01847, the contents of which are incorporated herein by reference. In such arrangements, it is desirable for the validator to store a table listing not only the currency units which can be handled by the validator, but also an indication of the currency to which they belong. This therefore allows the validator to be switched easily between different modes, in which different currencies are handled in different ways. For example, the validator can be switched between a first mode, in which only money of a first currency is received and dispensed, a second mode in which money of first and second currencies is validated but only money of the first currency is dispensed, a third mode in which money of the first and second currencies is accepted but only money of the second currency is dispensed, and a fourth mode in which only money of the second currency is validated and dispensed. In practice, the validator may be arranged only to be switchable between a sub-set of these modes. In any event, the techniques of the present invention facilitate the reconfiguration of the validator during changes between these modes.

The term currency is used in respect of denominations of coins which are legal tender in a given country and issued by a given authority. When two sets of denominations of coins are legal tender in a given country, as will be the case for the single European currency and the relevant national currency, they are deemed to be different currencies if they are issued by different authorities.

The invention also extends to a method of reconfiguring a money validator in accordance with the invention, and to a vending machine incorporating such a money validator.

Arrangements embodying the invention will now be described by way of example with reference to the accompanying drawings, in which:

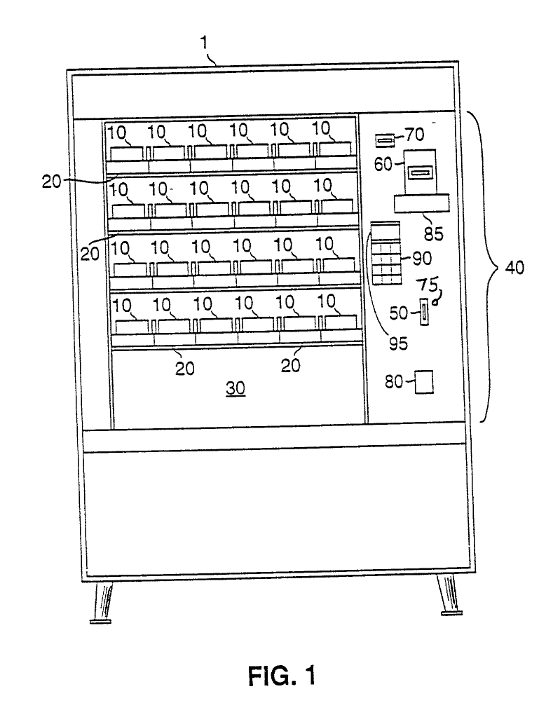

FIG. 1 is a front view of a typical vending machine which can operate according to the present invention;

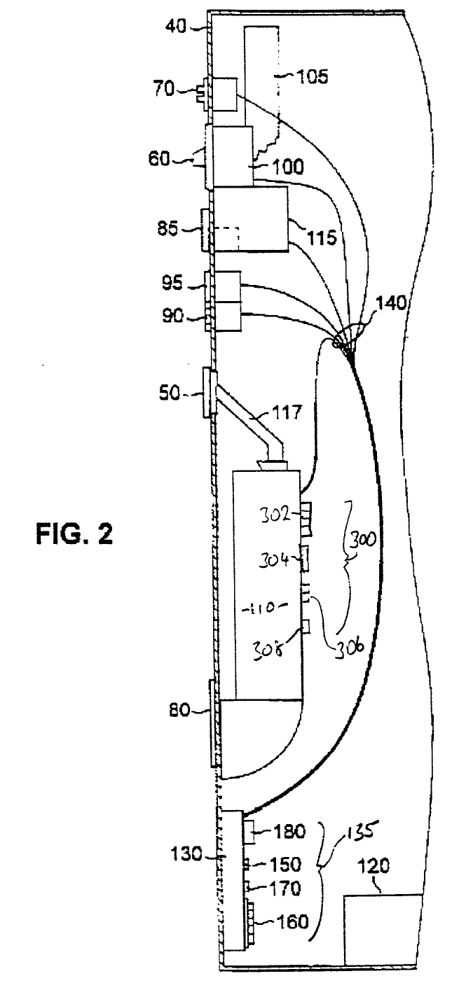

FIG. 2 is a partial cut-away side view of the front panel of the vending machine of FIG. 1;

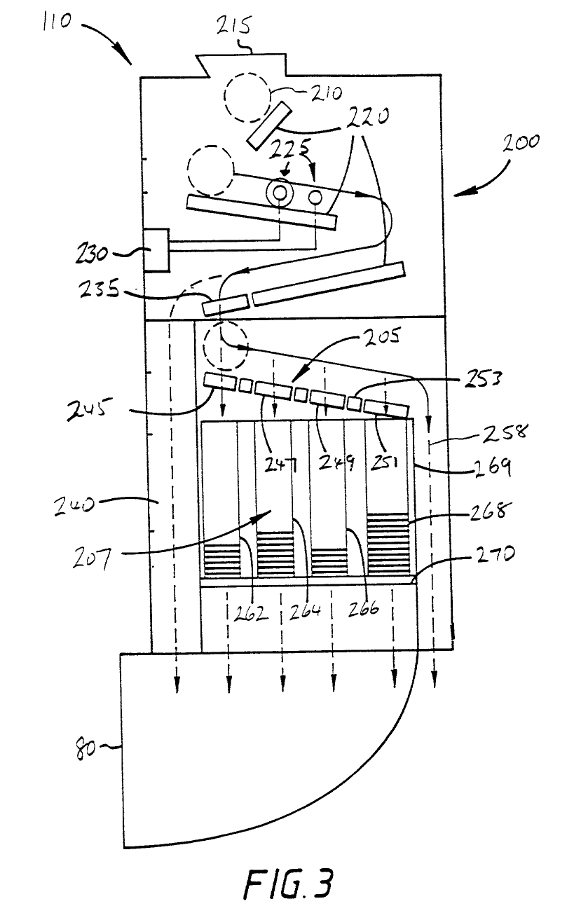

FIG. 3 is a schematic front view of a coin mechanism of the vending machine of FIG. 2; and

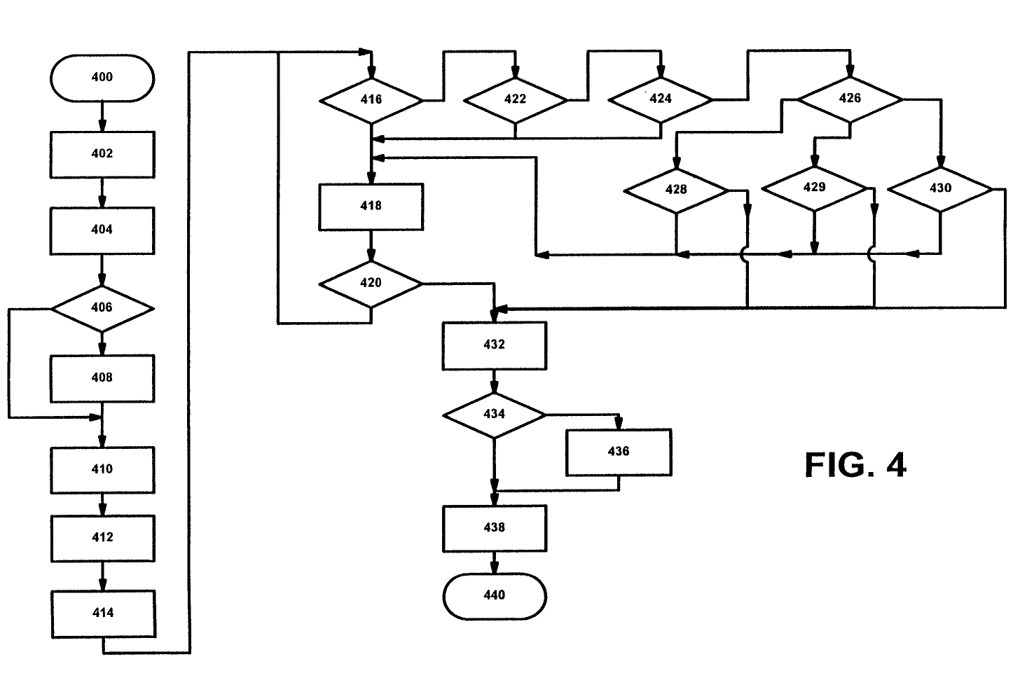

FIG. 4 is a flowchart of part of the operation of a coin validator in the vending machine.

The money acceptance apparatus and method of the present invention may be used for the dispensing of items including the vending of products, such as drinks, snacks, cigarettes, toiletries or tickets, currency exchange and the providing of services, such as in pay telephones or turnstiles. An embodiment of the invention is described below with reference to a product vending machine, but this is not meant to be a limitation on the application of this invention.

FIG. 1 illustrates a vending machine 1 which contains a variety of products 10 to be dispensed which are stored in an area inaccessible to customers, such as behind a glass panel. Each product 10 is retained by a product delivery apparatus 20 which is selectively actuable to dispense the product into a delivery area 30 that is accessible to the customer. Suitable product delivery apparatus 20 include vend motors and solenoids as well as others well known in the art. Examples of such apparatus include those described in U.S. Pat. Nos. 4,458,187 and 4,785,927, which are hereby incorporated by reference.

A control panel 40 of the vending machine 1 contains a coin slot 50 and a banknote or bill insert slot 60 which accept currency to initiate a vend operation. The control panel 40 further contains a card acceptor 70 to enable customers to initiate a transaction with a credit or debit card. In addition, an electronic purse device in the form of a card may be inserted into the card acceptor 70 to initiate a transaction. The term “electronic purse device” is used herein to denote a token or card possessing an electronic circuit, a magnetic strip or other data storing medium or circuitry, for retaining a credit value. An electronic purse device may be in one of a variety of shapes, including a key or coin, as well as the card. Such devices may be used as currency in a variety of conventional automatic transaction systems.

A coin return button 75, a coin return recess 80, a bill payout recess 85 and an item selector such as a keypad 90 are also provided in the control panel 40. A display 95 on the control panel 40 provides instructions and information to the customer. Suitable displays 95 include dot-matrix displays, selectively activatable message lights, an electronic scrolling message, or other displays capable of operating in the environmental conditions to which automatic transaction systems are typically exposed.

A customer may initiate a transaction by depositing coins or bills of particular denominations in the slots 50 or 60,respectively. The customer may also insert an electronic purse device, or a debit or credit card in the card acceptor 70 to initiate a transaction. Once sufficient payment has been deposited in the automatic transaction system 1, the customer may select a product 10 to be dispensed using the keypad 90. The corresponding product delivery apparatus 20 will then dispense the selected product 10 to the product delivery area 30 where it may be retrieved by the customer. Any resulting change from the transaction may be paid out through the coin return recess 80, the bill payout recess 85 or credited to an inserted electronic purse device. Before instructing a vend, a customer can press coin return button 75 to obtain a refund of coins in the amount of any coins he has inserted.

FIG. 2 is a partial cutaway side view, not drawn to scale, of the vending machine 1 of FIG. 1 showing a typical component layout along the control panel 40. Referring to FIG. 2, money acceptors, such as a bill validator 100 and a coin mechanism 110, are attached to the rear of the control panel 40 adjacent the bill insert and coin slots 60 and 50, respectively. The coin mechanism 110 is connected to the coin return recess 80 and to a coin passageway 117 leading to the coin slot 50. The bill validator 100 is connected to a bill stacker 105. The coin mechanism 110 and bill validator 100 are capable of discriminating coins and bills.

A bill escrow and payout unit 115 is positioned adjacent the bill payout recess 85 and is connected to the bill validator 100. The bill escrow and payout unit 115 is capable of dispensing bills as change through the bill payout recess 85. The bill validator 100 may divert deposited acceptable bills to the bill escrow and payout unit 115 to replenish its supply of bills for change. Suitable bill escrow and payout units 115 include those disclosed in U.S. Patent No. 5,076,441, as well as others well-known in the art. A cash box 120 is also included in the vending machine 1.

The bill validator 100, coin mechanism 110, bill escrow and payout unit 115, card acceptor 70, keypad 90 and display 95 are connected to a vend controller 130 by communication lines 140. The controller 130 is further connected to data input/output devices 135, such as DIP switches 150, a keypad 160, an input/output port 170 and a display 180 to facilitate entering and updating of operating data and servicing of the vending machine 1. The components disposed behind the control panel 40 are not accessible to customers of the vending machine 1 and may only be accessed by service personnel.

The controller 130 may be of a well known type, and may be arranged to receive various items of information from the bill validator 100 and coin mechanism 110 via the communication lines 140. In particular, each time an acceptable unit of money is validated by either the bill validator 100 or the coin mechanism 110, a signal is sent to the vend controller indicating the value of the received unit. For coins, this information is transmitted as a one-byte code, representing the denomination of the money unit according to a predetermined scaling factor SF, which scaling factor is stored within the controller 130. Values may be transmitted in a similar fashion by the bill validator 100, although in this case a separate scaling factor may be used.

The coin mechanism 110 is also provided with data input/output devices 300, including a keypad 302, display 304, DIP switches 306 and a communications port 308.

Further details of the coin mechanism 110 are illustrated in FIG. 3. Referring to FIG. 3, coin mechanism 110 comprises a coin validator 200, a coin separator 205 and a coin storage region 207. The coin validator 200 receives inserted coins 210 through an opening 215 which is connected to the coin passageway 117 of FIG. 2. The coin 210 travels along ramp 220 in the coin validator 200 past sensors such as those shown at 225.

The sensors 225 generate electrical signals which are provided to a coin mechanism processor 230 such as a microprocessor or microcontroller. Suitable arrangements for sensors 225 include those described in GB 1 397 083, GB 1 443 934, GB 2 254 948 and GB 2 094 008 which are hereby incorporated by reference.

The processor 230 is connected to the data input/output devices 300, the coin return button 75 of FIG. 1 and also to the vend controller 130 via communications lines 140, shown in FIG. 2.

The electrical signals generated by the sensors 225 contain information corresponding to the measured characteristics of the coin, such as a coin's diameter, thickness, metal content and electromagnetic properties. Based on these electrical signals, the processor 230 is able to discriminate whether the coin is acceptable, and if so, the denomination of the coin 210. The coin mechanism processor 230 provides information concerning the denomination of accepted coins to the controller 130 over the communication lines 140 of FIG. 2. For this purpose, the coin mechanism processor 230 also stores the scaling factor mentioned above, and transmits the value of the accepted coin denomination in units according to this scaling factor.

If the coin 210 is unacceptable, the processor 230 controls a gate 235 to direct the unacceptable coin 210 to a reject chute 240. The reject chute 240 is connected to the coin return recess 80 of FIGS. 1 and 2. In the alternative, acceptable coins 210 are directed to the coin separator 205 by the gate 235. The coin separator 205 may have a number of gates 245, 247, 249, 251 arranged along a ramp 253 and also controlled by signals from the processor 230, for diverting the coin 210 from the ramp 253.The coin 210 may be diverted into respective containers 262, 264, 266 and 268, or the coin 210 may be allowed to proceed along ramp 253 to a path 258 leading to the cash box 120 shown in FIG. 2.

Each of the containers 262, 264, 266 and 268 is in the form of a coin tube arranged to store a vertical stack of coins of a particular denomination. Although only four containers are shown, any number may be provided.

The coin tubes are arranged within a removable cassette 269; such removable cassettes are well known in the art. As an example, a removable cassette is described in GB 2 246 897 A, the contents of which are incorporated herein by reference. The removable cassette is marked with a code, which indicates the denominations that are accommodated by the tubes within the cassette. The code is input using the keypad 302 on the coin mechanism 110 to inform the mechanism which cassette and tubes have been installed. Alternatively, the design may be such that the mechanism automatically recognises the type of cassette when it is inserted, or else the information could be provided remotely, or on a card.

The coin mechanism 110 may alternatively use passive routing techniques, such as those well known in the vending machine art, instead of the gates 245-251 for diverting the coin 210 from the ramp 253. Examples of suitable alternative configurations for the coin separator 205 are described in U.S. Pat. Nos. 3,844,297 and 4,106,610, which are hereby incorporated by reference.

A dispenser 270 associated with the coin tubes 262-268 is operable to dispense coins from the containers when change is to be given to a customer by the coin mechanism 110. The dispensed coins are delivered to the coin return recess 80 for collection. Suitable dispensers 270 include those described in U.S. Pat. Nos. 3,814,115 and 4,367,760, which are hereby incorporated by reference. An alternative configuration may use a coin mechanism 110 that does not payout change. In such a configuration, a separate pre-loaded coin payout device, such as those well known in the gaming machine art, may be used to payout change.

Any bill validator that is capable of discriminating unique characteristics of bill denominations may be used as the bill validator 100 of FIG. 2. Suitable bill validators 100 include those described in U.S. Pat. Nos. 4,628,194 and 5,222,584, which are hereby incorporated by reference.

The apparatus described so far corresponds to known apparatus. The vend controller 130 may be of any of a number of different types. A first class of vend controller would allow the stored scaling factor to be changed manually using the data input/output devices 135, for example the DIP switches 150. A corresponding scaling factor would be caused to be stored in the coin mechanism processor 230 by a set-up procedure. This procedure would be carried out using the data input/output devices 300 of the coin mechanism, for example by operating the keypad 302, or by transmitting data to the processor 230 using a communications link coupled to the port 308. Either operation could be performed by a suitably-authorised service engineer. If the vending machine is of a second class, then upon initialisation of the vending machine 1 (which may occur on power-up of the vending machine), the vend controller 130 is arranged to receive a scaling factor transmitted over the communications lines 140 by the coin mechanism processor 230.

The processor 230 has one or more memories storing alterable data which can be changed by a service engineer in order to reconfigure the mechanism. In the present embodiment, the coin validator is capable of validating 32 different types of coins. For each coin type, the processor 230 stores acceptance criteria for use in determining whether the measured properties of a received coin under test correspond to the respective type. In addition, the processor 230 stores information represented in the follow table:

TABLE 1

| | | | RE- | | |
|---|---|---|---|---|---|
| NUMBER | VALUE | CURRENCY | MAINDER | TUBE? | INHIBIT |
| 1 | 100 | A | 0 | Y | N |
| 2 | 72 | B | 120 | N | N |
| 3 | 50 | A | 0 | N | N |
| 4 | 20 | A | 0 | Y | N |
| — | — | — | — | — | — |
| — | — | — | — | — | — |
| — | — | — | — | — | — |
| 32 | 5 | A | 0 | Y | Y |

Thus, for each coin there is stored a number identifying the coin and a parameter VALUE representing the value of the coin in units corresponding to the stored scaling factor SF. There are also stored an indication CURRENCY of the currency of the coin, a “remainder” value REMAINDER, an indication TUBE? of whether the coin is supposed to be stored in one of the tubes 262 to 268 and an “inhibit” flag INHIBIT. The inhibit flag is intended to indicate whether the validator should accept or disregard coins of this type.

In the present embodiment, the validator is intended to handle coins of a plurality of different currencies, for example Euros and British sterling. The values of money units of one currency are not integral multiples of the values of money units in the other currency. It would be possible to select a scaling factor representing a small value, and then to represent the values of the currency units accurately in the “VALUE” column of the table. However, this would mean that the number stored in the “VALUE” column would be large, therefore requiring potentially more than one byte for transmission. It would also not be very useful because normally the prices of the products or services provided by the vending machine would be in a single currency, and the coins which could be dispensed as change would also be in a single currency, so it would not be possible to deal effectively with fractions of units of this currency.

In the present embodiment, accordingly, the numbers used for the VALUE parameters of denominations in at least one currency are rounded, so that a larger scaling factor can be used to represent the different values for the respective currencies. However, an accumulation of rounding approximations could lead to a significant loss or gain of value. Various techniques are available for dealing with this. See for example WO-A-96/08795. In the present embodiment, the processor 230 stores the REMAINDER value. This represents any currency conversion inaccuracies resulting from the rounding used to obtain the VALUE parameter. Each time a coin is validated, the associated REMAINDER quantity is added to a remainder store. The processor determines when the amount accumulated in the remainder store is equal to or greater than a predetermined value, this value corresponding to the lowest denomination monetary unit which is capable of being dispensed by the validator. When this event occurs, the processor 230 transmits to the vending controller 130 an indication that a unit of this denomination has been received. This avoids the possibility of significant losses or gains due to rounding errors. The processor 230 also transmits to the vending controller 130 an indication that the unit was directed to the cashbox 120, so that the vending controller will not assume that the unit is available for dispensing. The remainder stored is cleared, or at least reduced by the amount corresponding to the lowest denomination monetary unit. The remainder store is also cleared at the end of each transaction. Various modifications will be apparent. The predetermined value could correspond to the lowest acceptable denomination, rather than the lowest dispensable denomination. Instead of taking account of the REMAINDER value as the customer is inserting coins, this could be taken into account after a vend selection is made, for determining whether sufficient credit has been inserted and/or for determining how much change should be dispensed.

Preferably, the REMAINDER value is stored in units which are smaller than that of the scaling factor, to increase accuracy.

The coin mechanism 110 of the present embodiment is designed to operate with vending machines of either of the two classes mentioned above. It is assumed in the following that the coin mechanism performs, during a set-up procedure, a communication operation with the vending machine controller 130 which informs the coin mechanism processor 230 of the particular type of vending machine controller with which it is communicating. However, instead, this information can be supplied to the coin mechanism processor 230 directly by a service engineer using the data input/output devices 300.

The set-up procedure for the coin mechanism 110 may be initiated on power-up of the coin mechanism and/or in response to a specific instruction from a service engineer, issued using the data input/output devices 300. FIG. 4 shows the set-up procedure insofar as it is relevant to the present invention.

The procedure starts at step 400. At step 402, the set-up procedure carries out standard configuration or re-configuration processes which will not be described in detail here, but which may involve processing information supplied by a service engineer using the data input/output devices 300. This information may include a scaling factor if the vend controller 130 is of a type which does not accept scaling factors provided to it over the communication lines 140. The supplied information may also result in altering the INHIBIT flags in table 1 to inhibit acceptance of particular coins which are not of interest in the region where the vending machine 1 is located. The set-up procedure may also involve changing the TUBE? flags identifying the denominations of coins stored in the coin tubes 262 to 268, if the coin mechanism is intended to dispense different types of coins (which might require replacement of the cassette 269 containing the coin tubes 262 to 268). These operations may be performed in order to change the mode of the apparatus such that it accepts and/or dispenses a different combination of currencies.

At step 404, the processor compiles a temporary table which lists all the coins which do not have their INHIBIT flags set, i.e. all the coins which the processor is currently arranged to validate.

At step 406 the processor determines the type of vending controller 130 to which it is connected. If it is connected to the type of controller which does not accept scaling factors transmitted over the communications lines 140, the program proceeds to step 408. This step is thus reached if the scaling factor has had to be provided to the coin mechanism. At step 408, the processor checks all the coins in the table created at step 404, to determine whether the value associated with each coin is evenly divisible by the scaling factor. If, for any coin, the value is not evenly divisible by the scaling factor, then the INHIBIT flag for that coin is set, and the coin is disregarded during the further processing discussed below.

The program then proceeds to step 410, which is reached immediately after step 406 if the coin mechanism 110 is connected to a vending processor 130 which is capable of accepting scaling factors transmitted along the communications link 140.

At step 410, the processor 230 sorts all the coins in the temporary table created at step 404. The table is sorted according to coin value.

In addition to genuine minted coins, the coin validator is also capable of accepting value tokens and vend tokens. Value tokens are specially-manufactured tokens for a particular customer or customer group, and have values associated with them which are similar to the values associated with genuine minted coins. These therefore can be sorted along with the genuine coins according to their value. Vend tokens are specially-manufactured tokens which do not have a specific value associated with them. Instead, each token (or a combination of a particular number of tokens) allows a vend of unspecified price to take place. These vend tokens are treated, when the table is sorted, as though they had a higher value than any of the genuine minted coins or value tokens.

At step 412, the processor determines N, which is the maximum number of coins which can be recognised by the vend controller 130. Some vend controllers, for example, can recognise no more than 16 distinct types of coins. This information can be provided by the service engineer, or can be obtained from the vend controller 130 via the communication lines 140.

At step 414, an internal counter n is set equal to zero.

At step 416, the processor 230 checks through the coins in the temporary list until it finds a coin for which the associated TUBE? flag is set. If such a coin is found, the program proceeds to step 418. Here, the coin located in the list is selected for acceptance, which will ensure that its INHIBIT flag will not be set. Also, the value n is incremented by one. The program proceeds to step 420. Here, the program determines whether n=N, which would mean that the maximum number of coins that can be handled by the controller 130 has been reached. If not, the program loops back to step 416.

The program continues in this way until the program fails to find any more coins for which the TUBE? flag is set. The program then proceeds to step 422, to determine whether there are any vend tokens in the temporary list. If so, they are successively selected for acceptance at step 418. If not, the program proceeds to step 424 to determine whether there are any value tokens in the temporary list. If so, these are also successively selected for acceptance at step 418. If not the program proceeds to step 426.

At step 426, the program determines whether the coins that are sent to the change tubes, i.e. the coins with the TUBE? flag set, are grouped predominantly toward the lower value coins in the sorted list, or whether they are closer to the higher value coins. This step is performed by counting how many denominations, amongst the coins which are acceptable to the validator, are lower than the lowest denomination coin for which the TUBE? flag is set, and how many of these coins have a higher denomination than the highest-denomination coin for which the TUBE? flag is set. The program then proceeds to step 428, 429 or 430 in dependence on whether the tube denominations are closer to the lower denomination acceptable coins, or distributed mid-way between the lower and higher denomination coins, or closer to the higher denomination coins, respectively.

At step 428, the program looks for the lowest remaining value in the temporary table. If one exists, the program proceeds to step 418. At step 430, the program looks for the highest remaining value in the temporary table, and if one exists the program proceeds to step 418. At step 429, the program looks for the lowest remaining value in the temporary list and then proceeds to step 418 on the first occasion step 429 is reached, and then on the next occasion checks for the highest remaining value, and this alternates each time step 429 is reached. The result of steps 428, 429 and 430 is to select for acceptance coins which are closest in value to the coins which are stored for dispensing.

Step 418 is reached whenever a coin is located at any of steps 416, 422, 424, 428, 429 and 430. As indicated above, each time this step is reached, a different coin is selected for acceptance.

If, at step 428, 429 or 430, it is determined that there are no further coins in the temporary list, the program proceeds straight to step 432. This step is also reached after N coins from the temporary list have been selected.

At step 432, any coins remaining in the temporary list have their INHIBIT flags set.

At step 434, the program again checks the class of the vending machine controller 130. If it is a class that will respond to transmitted scaling factors, the program proceeds to step 436. At this step, the program calculates the highest common factor of all the values stored in table 1, excluding those values associated with inhibited coins and excluding any vend tokens. This value is then stored as the scaling factor.

Preferably, this procedure involves initially setting the scaling factor to be equal to the lowest value associated with the coins in consideration. Then, the program checks that all coins of a higher value are divisible by the scaling factor. If so, then this value is used as the final coin scaling factor. If not, one is subtracted from the scaling factor and the checking procedure is carried out again. This process is repeated until a coin scaling factor is calculated. Once the scaling factor has been calculated, it is transmitted to the vending machine processor 130 over the communication lines 140.

At step 438, a final check is performed to ensure that all the coin values which do not have their INHIBIT flags set, when divided by the scaling factor, produce a value which is less than or equal to 255, which is the largest value that can be reported to the vending machine controller 130. Any coins which fail this check have their INHIBIT flags set.

The final result of this procedure is:

(a) If the vending machine is of a type which will not respond to transmitted scaling factors:

(i) all coins for which the provided scaling factor is inappropriate are excluded from validation; and

(ii) a sub-set of coins to be accepted by the validator is generated by excluding coins in the validator's coin set, giving priority to allowing acceptance of coins which are routed to the change tubes 262 to 268, followed by vend tokens, followed by value tokens, and then followed by further coins having values biassed toward the values of the change tube coins;

(b) If the vending machine controller 130 is capable of responding to transmitted scaling factors:

(i) a sub-set of coins to be accepted by the validator is generated, giving priority to allowing acceptance of coins which are routed to the change tubes 262 to 268, followed by vend tokens, followed by value tokens, and then followed by further coins having values biassed toward the values of the change tube coins; and

(ii) an appropriate scaling factor is calculated and transmitted to the vending machine controller 130.

Although the flowchart of FIG. 4 is intended to represent a set-up procedure executed by the coin validator, it could also or alternatively represent a set-up procedure performed by the bill validator.

In the above embodiment, the scaling factor is only calculated and transmitted to the vend controller if the vend controller is of a type which is capable of responding to such a transmitted scaling factor. However, it may be advantageous to have the money validator calculate the scaling factor even if this cannot be automatically transmitted to the vend controller. Instead, a display of the scaling factor may be provided, so that this can be manually input to the vend controller.

The invention has been described in the context of coin validators, but it is to be noted that the term “coin” is employed to mean any coin (whether valid or counterfeit), token, slug, washer, or other metallic object or item, and especially any metallic object or item which could be utilised by an individual in an attempt to operate a coin-operated device or system. A “valid coin” is considered to be an authentic coin, token, or the like, and especially an authentic coin of a monetary system or systems in which or with which a coin-operated device or system is intended to operate and of a denomination which such coin-operated device or system is intended selectively to receive and to treat as an item of value.

1. A money validator operable in first and second modes, the money validator being operable in the first mode to respond to a predetermined scaling factor by selectively inhibiting acceptance of monetary units, and the money validator being operable in the second mode to respond to a selection of monetary units that can be accepted by calculating a scaling factor.

2. A money validator which is operable to transmit and/or receive money values in units determined by a stored scaling factor, the mechanism being operable to calculate, from the values of denominations acceptable to the validator, a scaling factor.

3. A validator as claimed in claim 2, wherein the validator is further arranged to transmit a signal representing the calculated scaling factor.

4. A validator as claimed in claim 2 or claim 3, wherein the validator is capable of accepting a plurality of denominations, and is further capable of selecting a sub-set of such denominations and inhibiting the acceptance of denominations which are not in said sub-set, the scaling factor being calculated on the basis of the values of the denominations of said sub-set.

5. A validator as claimed in claim 4, wherein the validator is capable of storing monetary units of selected denominations in such a manner that they can be dispensed as change, and wherein the sub-set is determined taking into account said selected denominations.

6. A money validator which can be arranged to validate monetary units of different denominations within a money set, and which is operable to generate and/or receive a signal representing a monetary value in units determined by a stored scaling factor, wherein the validator has means for selectively inhibiting individual denominations of said money set in dependence on the value of said scaling factor.

7. A validator as claimed in claim 6, wherein the validator is operable to inhibit acceptance of denominations whose values are not integer divisible by the scaling factor.

8. A validator as claimed in claim 6 or claim 7, wherein the validator is arranged to cause some accepted denominations to be stored in such a manner that they can be dispensed as change, and wherein the validator is arranged to take into account which such denominations can be dispensed as change when determining which denominations to inhibit.

9. A money validator which is automatically operable to select for acceptance a sub-set of monetary units from a set which is nominally capable of being handled by the money validator, the selection taking into account parameters including the monetary units which can be dispensed by the money validator.

10. A money validator as claimed in claim 9, wherein the money validator also takes into account a supplied scaling factor in selecting the sub-set.

11. A money validator as claimed in claim 9, wherein the money validator calculates a scaling factor from the selected sub-set.

12. A coin validator as claimed in any preceding claim.

13. A vending machine having a money validator as claimed in any preceding claim.

14. A method of configuring a money validator in which a scaling factor is supplied to the validator and the validator uses the scaling factor and the values of denominations which can nominally be accepted by the validator for automatically determining which denominations should be inhibited from acceptance.

15. A method of configuring a money validator, in which the money validator uses the values of denominations of monetary units which can be accepted by the validator in order to calculate a scaling factor, the money validator thereafter being operable to send and/or receive information relating to monetary values in units determined by the scaling factor.
